(19) United States
(12) Patent Application Publication
(10) Pub. No.: US 2005/0089678 A1
(43) Pub. Date: Apr. 28, 2005

(54) Multi-layered floorig composite including an acoustic underlayment

(76) Inventor: Steven R. Mead, Broomfield, CO (US)

Correspondence Address: W. Scott Carson, Esq.;Dorr, Carson, Sloan & Birney, P.C., 3010 East 6th Avenue, Denver, CO, 80206, US

(21) Appl. No.: 10/645,720

(22) Filed: Aug. 20, 2003

(51) Int. Cl. B32B 5/16

(52) U.S. Cl. 428/323

(57) ABSTRACT

A multi-layered flooring composite with an acoustic underlayment. In one embodiment, the acoustic underlayment or layer includes a plurality of discrete beads of substantially elastic, resilient material. Portions of adjacent beads abut one another and other portions of the adjacent beads are spaced from each other. In the preferred embodiment, substantially all of the adjacent beads are integrally joined together at their abutting portions. The beads preferably have substantially truncated spherical shapes and are made of closed cell foam.

### BACKGROUND OF THE INVENTION

1. Field of the Invention

This invention relates to the field of flooring and more particularly to the field of acoustic underlayments for flooring.

2. Discussion of the Background

Common flooring designs include multi-layers of components. The upper or finished layer can be made of any number of materials such as tile, natural wood, or compressed matter (e.g., fibers) which may even have a photolaminate surface simulating a natural wood grain. The finished layer is positioned above the subfloor (e.g., plywood, concrete, particle board) with various intermediate or underlayment levels therebetween. Such underlayments typically include a padding layer and a moisture-proof film layer.

Padding layers can be made of a wide variety of materials including rubber, cork, and foam. In multi-level homes and buildings, sound reduction is an important characteristic and it is desirable that the padding (especially on upper floors) have sound absorbing and low transmission qualities. Various industry standards are used to measure such sound qualities including the Impact Insulation Class (IIC) tests. These tests primarily rate sound transmission through an overall flooring composite with an 1/8 inch layer of padding. A padding layer that receives an ICC rating greater than 50 is normally considered in the trade to be an acoustic underlayment, which is highly desirable and often required by architects and building codes.

In this light, the present invention was developed. With it, a multi-layered flooring composite is provided with an acoustic pad layer that has highly desirable overall qualities including sound absorption and low sound transmission as well as moisture control.

### SUMMARY OF THE INVENTION

This invention involves a multi-layered flooring composite with an acoustic underlayment. The acoustic underlayment or layer of the preferred embodiment includes a plurality of discrete beads of substantially elastic, resilient material (e.g., foam). Portions of adjacent beads abut one another and other portions of the adjacent beads are spaced from each other. In the preferred embodiment, substantially all of the adjacent beads are integrally joined together at the abutting portions thereof.

In one embodiment of the invention, the beads have substantially truncated spherical shapes. Additionally, the beads are made of waterproof material such as closed-cell foam (e.g., polyethylene, polypropylene) and are of relatively light densities. The beads are preferably about 85%-95% air and the ambient air in the interstitial spaces between the beads makes up about 35%-40% of the total volume of the acoustic layer. With the acoustic layer positioned underneath the top or finished floor layer, any moisture penetrating the top floor layer can be received and dissipated into the interstitial spaces between the beads to prevent damage to the finished floor layer. A moisture-proof film can also be used with the acoustic layer if desired for additional moisture control.

The acoustic layer of the present invention can also be used as a resonant underlayment in a composite subfloor structure. In such use, the acoustic layer is positioned between two layers of relatively hard material such as concrete and plywood. Like the locally applied underlayment beneath the top or finished floor, the resonant underlayment absorbs sound and lessens the transmission of sound between the floors in a home or building.

### BRIEF DESCRIPTION OF THE DRAWINGS

FIG. 1 is a cross-sectional view of the multi-layered flooring composite of the present invention.

FIG. 2 is a plan view taken along line 2-2 of FIG. 1 showing the beads of the acoustic layer of the flooring composite of FIG. 1.

FIG. 3 is cross-sectional view similar to FIG. 1 but with the moisture-proof film layer positioned above the acoustic layer of beads.

FIGS. 4-5 illustrate a technique for integrally joining the moisture-proof film layer to the beads of the acoustic layer.

FIG. 6 is a cross-sectional view similar to FIG. 1 but with beads made of a different material.

FIG. 7 is a plan view taken along line 7-7 of FIG. 6 showing the beads of the acoustic layer of the flooring composite of FIG. 6.

FIG. 8 is a view similar to FIG. 6 but additionally showing an application of the beads as a resonant underlayment in a composite subfloor structure.

### DETAILED DESCRIPTION OF THE INVENTION

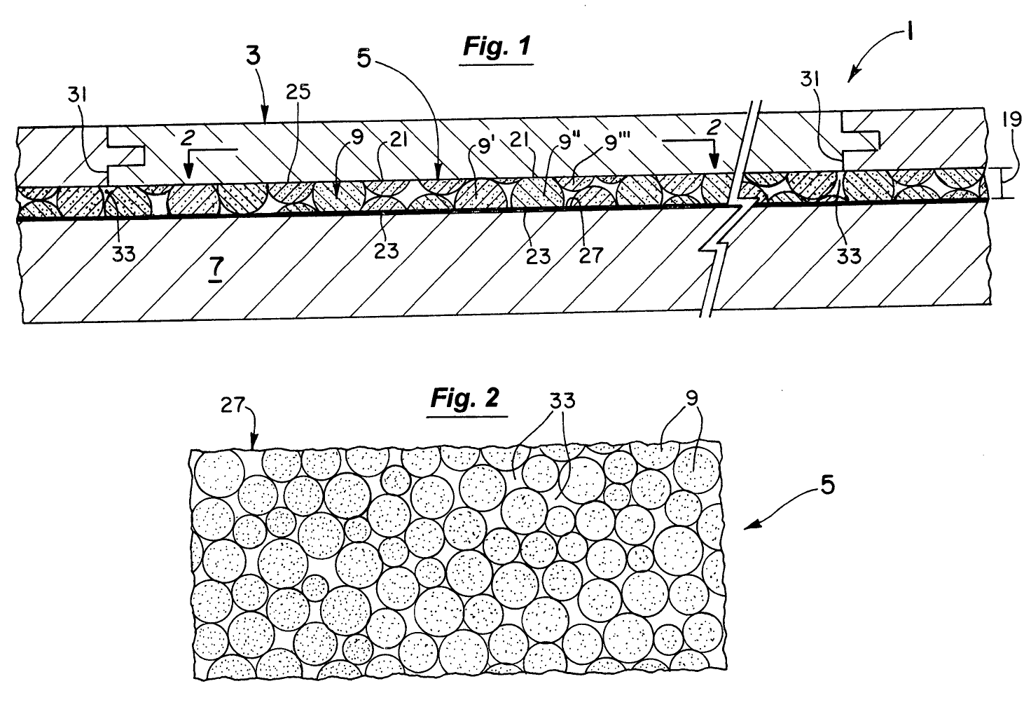

As shown in FIG. 1, the multi-layered flooring composite 1 of this embodiment of the present invention includes a top or finished floor layer 3 and an acoustic underlayment 5. The acoustic underlayment or layer 5 as illustrated is positioned underneath the top floor layer 3 between the top floor layer 3 and the subfloor layer 7 (e.g., plywood, concrete, particle board). The top floor layer 3 is preferably made of a relatively hard material such as tile, natural hard wood, or a compressed plastic or fibrous material such as 3 in FIG. 1 with a photolaminate upper surface intended to simulate a wood grain.

The acoustic layer 5 includes a plurality of discrete beads 9 of substantially elastic, resilient material (e.g., polyethylene, polypropylene) that can be deformed wherein the beads will rebound to their original shapes of FIG. 1. This is in contrast to materials such as polystyrene that are essentially incompressible in normal use and crush under excessive loads. In the embodiment of FIGS. 1 and 2, the beads 9 have substantially truncated spherical shapes wherein portions of adjacent beads abut one another and other portions are spaced from each other. Additionally, substantially all of the adjacent beads 9 are preferably integrally joined (e.g., glued, fused) together at the abutting portions thereof.

The beads 9 of FIGS. 1 and 2 originated as part of a billet of integrally joined, full beads wherein the billet is cut creating the truncated spherical shapes as illustrated. In this regard, the diameters of the full beads of the billet can vary as desired (e.g., 1/16 to 5/16 inches or more) but preferably, the diameters are greater than the desired thickness 19 of the cut, acoustic layer 5. Consequently, for example, with original beads of a substantially uniform diameter of 1/4 inch and a final desired thickness of the industry standard 1/8 inch as in FIG. 1, the beads 9 are truncated with one or more flat, horizontal surfaces 21 and 23. Further, the upper surfaces 21 of the cut, acoustic layer 5 are substantially coplanar as are the lower surfaces 23. The coplanar upper surfaces 21 can then be positioned adjacent or abutting the substantially flat, lower surface 25 of the top floor layer 3 (see FIG. 1). Similarly, the coplanar surfaces 23 (with or without the moisture-proof film layer 27) can be placed adjacent or abutting the upper, flat surface of the subfloor 7.

The truncated shape of each individual bead in the cut, acoustic layer 5 in the above example can vary. As for example and as illustrated in FIG. 1, beads such as 9′ can be semi-spherical with essentially a point contact with the lower surface 25 of the top floor layer 3 or inversely with a point contact with the film layer 27. The truncated beads can also be in the shape of spherical sections 9″ with two, flat and parallel surfaces on their tops 21 and bottoms 23 or spherical segments 9′″ with only one flat surface. The original, full beads in the billet from which acoustic layer 5 was cut could also have varying diameters if desired with some beads being whole in the cut, acoustic layer 5. The beads 11 of the acoustic layer 5 could also have multiple levels of complete beads if desired with the upper and lower levels then being cut to form the upper and lower surfaces 21 and 23. However, in the preferred and illustrated embodiment of FIGS. 1 and 2, the original, full beads were preferably uniform spheres of substantially the same size with a diameter (e.g., 1/4 inch) greater that the cut thickness 19 (e.g., 1/8 inch) of the acoustic layer 5. From the perspective of the truncated beads 9 of FIG. 1, their projected diameters (i.e., as if they were full beads) would then be 1/4 inch in this example. Because adjacent beads 9 are integrally joined (e.g., glued, fused) together, the beads 9 act together. Consequently, forces applied to or concentrated on particular beads 9 or areas of beads 9 under the top floor layer 3 are dissipated or spread out by the interaction of the integrally joined beads 9. In some cases, the beads that are directly compressed under the force will apply pressure outwardly and compress laterally adjacent beads not directly under the force. In other cases, adjacent and integrally joined beads will be drawn toward the compressed beads. In the preferred embodiments and with adjacent beads 9 being so joined, the beads 9 will not separate in use and the top floor layer 3 will then not bottom out (e.g., abut against the subfloor layer 7) when forces are applied to the top floor layer 3.

The density of the acoustic layer 5 (including the foam beads 9 and the bonding agent (e.g., polyurethane) joining the abutting portions of the beads 9) can vary as desired but preferably is in the range of 2-3 pounds per cubic foot under lighter top floor layers 3 (e.g., natural wood or laminate) and slightly higher (5-10 pounds per cubic foot) under heavier top floor layers 3 such as tile. The density of the foam of the beads themselves is about 0.5 to 2.0 pounds per cubic foot. In all cases, the foam is preferably closed-cell so as to be waterproof (i.e., non-absorbent). Additionally, for enhanced acoustic properties, the acoustic layer 5 is preferably mostly air. The air spaces 33 (see FIG. 2) between the beads 9 in this regard occupy about 25%-45% and preferably 35%-45% of the total volume of the acoustic layer 5 with the beads 9 occupying the remainder. The beads can be 30%-90% air but preferable are about 65%-95% air depending upon the foam density. The less dense acoustic layers (2-3 pounds per cubic foot) of FIGS. 1 and 2 would preferably make the overall air volume of the acoustic layer 5 about 90%-95% (i.e., interstitial air spaces 33 between the beads 9 of about 35%-45% plus the air in the beads 9 themselves of about 85%-95%). The denser acoustic layers (5-10 pounds per cubic foot) for use under tiles may make the overall air volume of the acoustic layer 5 about 75%-85% (i.e., interstitial air spaces between the beads of about 35%-45% plus the air in the beads themselves of about 65%-75%). The overall Impact Insulation Class rating of the acoustic layer 5 in either case is preferably greater than 50 and normally in the range of 55 or higher.

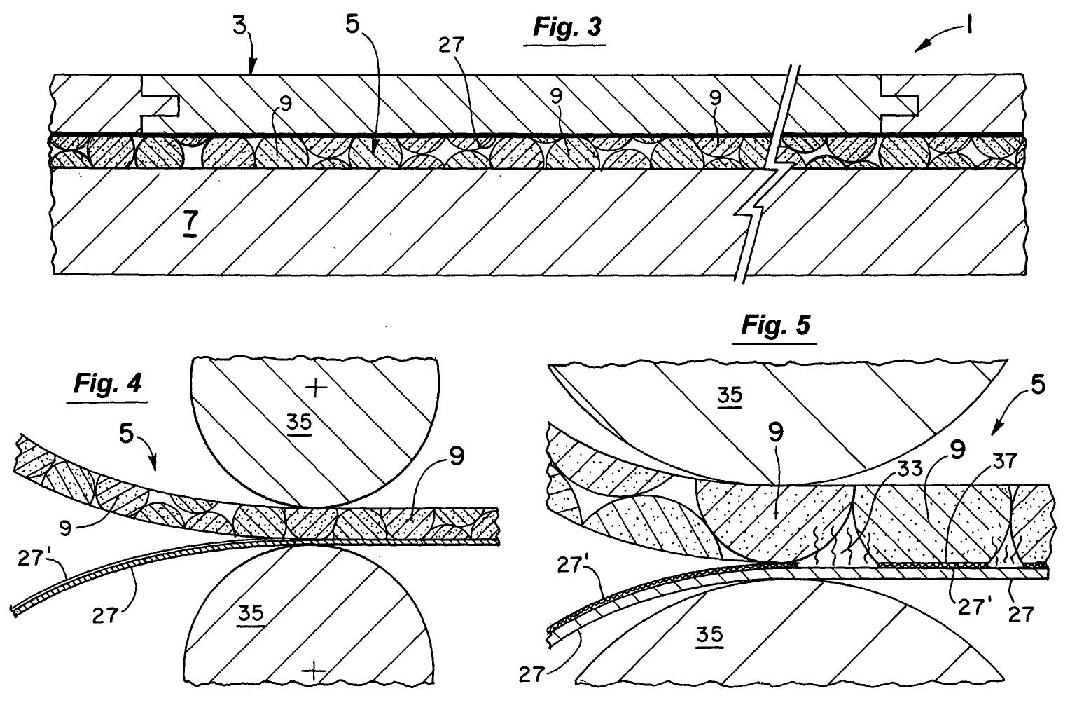

As discussed above, the multi-layered flooring composite 1 can include a moisture-proof film barrier 27 that is preferably positioned below the beads 9 of the acoustic layer 5 as in FIG. 1. However, the flooring composite 1 of the present invention can be used without a film layer 27 or the film layer 27 can be positioned above the beads 9 as illustrated in FIG. 3 or both above and below the beads 9. Preferably, the flooring composite 1 does have such a moisture-proof film 27 (e.g., 0.010 to 0.030 inches thick) positioned below the beads 9 as in FIG. 1. Consequently, any moisture (e.g., water) passing through the top floor layer 3 (e.g., through joint cracks 31 in FIG. 1) will be received in the ambient air spaces (e.g., 33) between the adjacent beads 9 and prevented by the film 27 from passing down to the subfloor 7. The air spaces of the acoustic layer 5 in this regard are in fluid communication with one another essentially thorough out the entire acoustic layer 5. Consequently, any such moisture will be drawn or flow downwardly away from the top floor layer 3 and be dissipated or evaporated in the air volume of the interstitial spaces 33 between the beads 9. Moisture damage (e.g., rot) to the material of the top floor layer 3 can then be avoided as can any such damage to the subfloor 7.

The film layer 27 of FIGS. 1 and 3 can be free floating (i.e., not attached) to the beads 9 of the acoustic layer 5 or can be secured to the beads 9. Similarly, the beads 9 of the acoustic layer 5 in FIGS. 1 and 3 can be free floating or attached to the top floor layer 3 or to the subfloor layer 7. In the preferred embodiments with the moisture-proof film layer 27 attached or integrally joined (e.g., glued, fused) to the beads 9, the preferred technique to do so is illustrated in FIGS. 4 and 5. As shown, the beads 9 of the acoustic layer 5 and the moisture-proof film 27 are pressed together as illustrated in FIG. 4 between two, heated rollers 35. The moisture-proof film 27 in this regard preferably is made of a relatively high density polyethylene or polypropylene and initially has a layer of relatively low density polyethylene or polypropylene 27′ on it. The low density layer 27′ is essentially a sacrificial layer as it melts at the relatively low temperature of the heated rollers 35 to then secure the beads 9 to the high density layer 27 (which is not melted by the temperatures of the rollers 35). Any portion of the low density layer 27′ at an interstitial space 33 between beads 9 (see FIG. 5) then simply evaporates away. The end result is that the high density layer 27 is integrally joined at the contact locations 37 in FIG. 5 with the beads 9 of the acoustic layer 5.

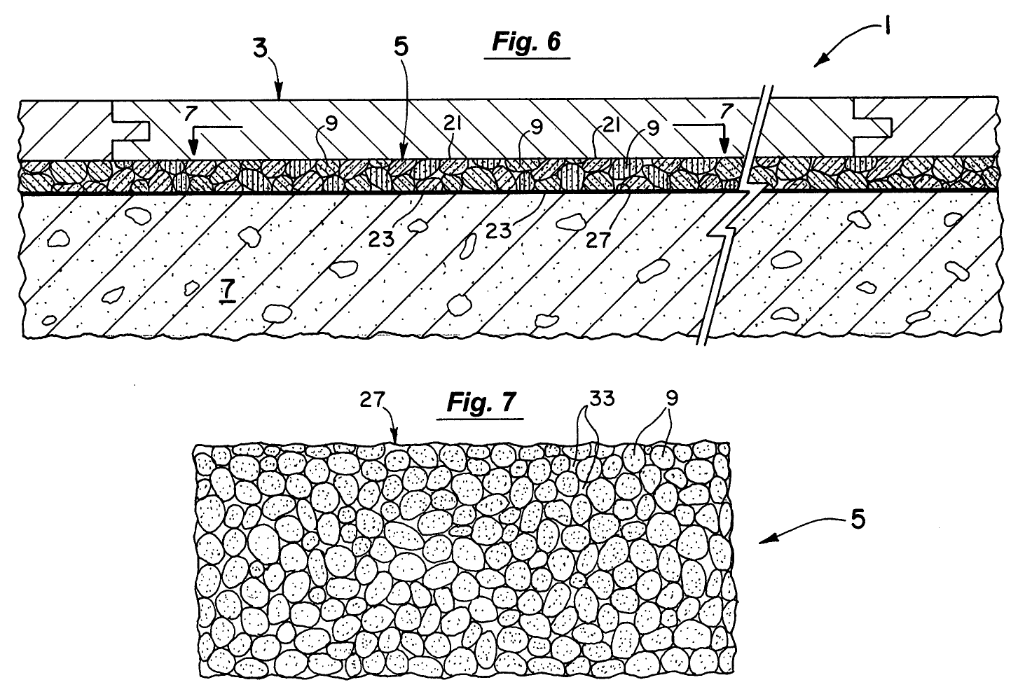

The shapes of the beads 9 of the acoustic layer 5 in FIG. 1 are preferably substantially truncated spheres. As discussed above, the original beads of the billet from which the acoustic layer 5 of FIGS. 1 and 2 is cut are preferably substantially spherical shapes of uniform diameters. However, the original beads can be a mix of diameter sizes as in the embodiment of FIGS. 6 and 7. Further and although still substantially truncated as in FIGS. 6 and 7, the original, rounded beads of the billet can have less than perfect spherical shapes. Polyethylene foam in this regard tends to create more nearly spherical beads as in FIGS. 1 and 2 while beads of polypropylene as in FIGS. 6 and 7 tend to be less than ideal spheres. Nevertheless, the spherical description of these beads in this disclosure is intended to cover both examples as well as other rounded beads. Additionally, and regardless of the closeness to being nearly perfect spheres, the solid beads 9 of the acoustic layer 5 in the embodiments of FIGS. 1-2 and 6-7 still have the flat, substantially horizontal and coplanar surfaces 21 and 23. The coplanar surfaces 21 and 23 can then be aligned with the substantially flat, lower surface of the top floor layer 3 or the substantially flat, upper surface of the subfloor 7.

The beads 9 as discussed above are preferably made of elastic, resilient materials such as polyethylene or polypropylene but could be made of inelastic, crushable materials such as polystyrene that are essentially incompressible in normal use. The acoustic layer 5 could additionally be a mix or blend of beads of these materials if desired. The beads can be in multiple levels and include whole and truncated shapes. In the preferred embodiments, the abutting portions of the beads are integrally joined (e.g., glued, fused) but could be simply abutting if desired.

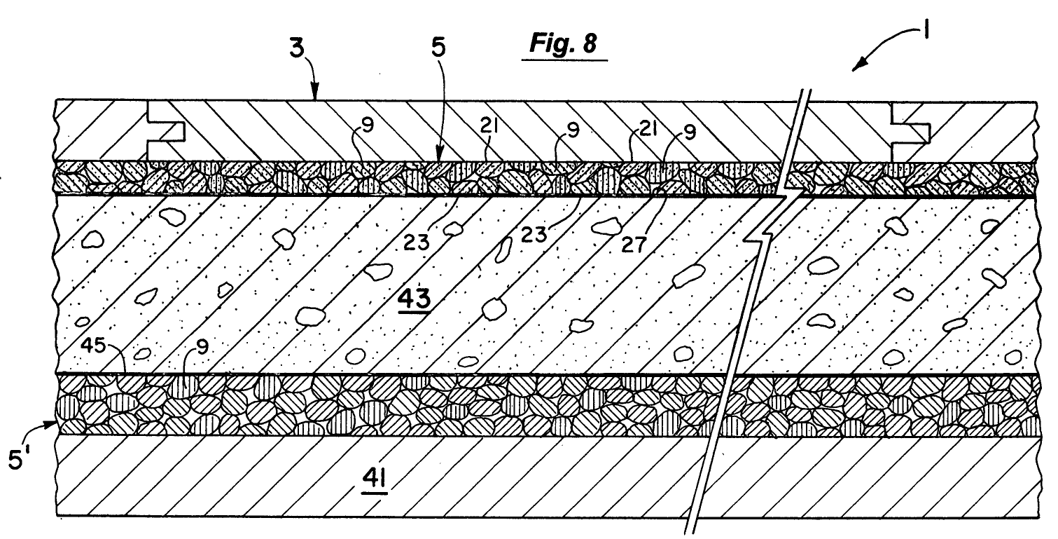

FIG. 8 is a view similar to FIG. 6 but additionally showing an application of the beads 9 as a resonant underlayment 5′ in a composite subflooring structure. More specifically, the acoustic layer 5 discussed so far has been shown and discussed in use as a locally applied underlayment. Such locally applied underlayments are used immediately adjacent the top floor layers like 3 that are essentially finished flooring such as natural wood, laminates, and tile. Resonant underlayements such as 5′ in FIG. 8 are used for similar acoustic reasons to absorb sound and limit its transmission between floors. However, resonant underlayments such as 5′ are positioned as shown in FIG. 8 between components such as 41 and 43 of the subflooring structure. For the most part, resonant underlayments become an integral part of the home or building itself as opposed to the removable and replaceable layers 3 and 5 of the earlier embodiments.

In this regard, the acoustic layer 5′ includes the beads 9 as in the earlier embodiments, which beads 9 can be in multiple levels as illustrated in FIG. 8 and as discussed in regard to the earlier embodiments. The beads 9 can also include a mix of beads of different materials (e.g., polyethylene, polypropylene, polystyrene) and diameters as well as whole and truncated beads as also previously discussed. In use, the acoustic layer 5′ is preferably placed atop the subfloor component 41 of relatively hard material (e.g., plywood, concrete) between the component 41 and the component 43, which is also made of relatively hard material such as concrete or a mixture of concrete and gypsum. As opposed to the acoustic layer 5 of the previous embodiments, the embodiment of FIG. 8 preferably has a fabric layer 45 (e.g., non-woven polyethylene, polyester) on top of the beads 9 so the component layer 43 can be more easily poured or formed over the acoustic layer 5′.

While several embodiments of the present invention have been shown and described in detail, it to be understood that various changes and modifications could be made without departing from the scope of the invention.

1. A multi-layered flooring composite for use over a subfloor layer, said composite including a top floor layer of substantially hard material and at least one acoustic layer positionable thereunder between said top floor layer and said subfloor layer, said acoustic layer including a plurality of discrete beads of substantially elastic, resilient material wherein portions of adjacent beads abut one another and other portions of said adjacent beads are spaced from each other to create spaces therebetween and wherein substantially all of said adjacent beads are integrally joined together at the abutting portions thereof.

2. The flooring composite of claim 1 wherein at least some of said beads have substantially truncated spherical shapes.

3. The flooring composite of claim 2 wherein substantially all of said beads have truncated spherical shapes with at least one substantially flat, horizontal surface.

4. The flooring composite of claim 3 wherein at least some of said at least one flat, substantially horizontal surfaces of said beads are substantially coplanar.

5. The flooring composite of claim 4 wherein said coplanar surfaces are positioned substantially adjacent said top floor layer.

6. The flooring composite of claim 4 wherein said coplanar surfaces are positioned in a substantially abutting relationship with said top floor layer.

7. The flooring composite of claim 4 wherein said coplanar surfaces are positioned in an abutting relationship with said top floor layer.

8. The flooring composite of claim 7 wherein any moisture between said top floor layer and said acoustic layer can be received in said spaces between said other portions of said adjacent beads.

9. The flooring composite of claim 8 wherein said spaces between said other portions of said adjacent beads are in fluid communication with one another.

10. The flooring composite of claim 1 wherein at least some of said beads have substantially truncated spherical shapes with at least two substantially flat surfaces.

11. The flooring composite of claim 10 where said at least two substantially flat surfaces of said some beads are spaced from one another and substantially parallel to each other.

12. The flooring composite of claim 11 wherein said at least two substantially flat, parallel surfaces of said some beads are substantially coplanar with corresponding flat surfaces of each other.

13. The flooring composite of claim 1 further including a substantially moisture-proof film layer positioned adjacent said acoustic layer.

14. The flooring composite of claim 1 further including a substantially moisture-proof film layer positioned below said acoustic layer between said acoustic layer and said subfoor layer.

15. The flooring composite of claim 14 wherein said film layer is integrally joined to at least some of said beads.

16. The flooring composite of claim 1 further including a substantially moisture-proof film layer positioned above said acoustic layer between said acoustic layer and said top floor layer.

17. The flooring composite of claim 1 wherein said beads are made of foam.

18. The flooring composite of claim 17 wherein said foam is a closed cell foam.

19. The flooring composite of claim 18 wherein said closed-cell foam is polyethylene.

20. The flooring composite of claim 18 wherein said closed-cell foam is polypropylene.

21. The flooring composite of claim 1 wherein the density of said acoustic layer is about two to ten pounds per cubic foot.

22. The flooring composite of claim 1 wherein said spaces between said other portions of said adjacent beads are in fluid communication with one another.

23. The flooring composite of claim 1 wherein said acoustic layer has a thickness and substantially all of said beads have a substantially truncated spherical shape wherein the projected diameters of said substantially spherical shapes are greater than said acoustic layer thickness.

24. The flooring composite of claim 23 wherein said acoustic layer thickness is about 1/8 inch and said projected diameters are greater than 1/8 inch.

25. The flooring composite of claim 24 wherein said projected bead diameters are substantially the same.

26. The flooring composite of claim 25 wherein said projected bead diameters are about 1/4 inch.

27. The flooring composite of claim 1 wherein the beads of said acoustic layer are made of closed cell foam and are about 75%-95% air.

28. The flooring composite of claim 1 wherein the spaces between said other portions of said adjacent beads make up about 35% to 45% of the total volume of the acoustic layer.

29. The flooring composite of claim 1 wherein the beads of said acoustic layer are made of closed-cell foam and the total volume of the acoustic layer including the beads and the spaces between said other portions of said adjacent beads is about 75% to 95% air.

30. The flooring composite of claim 1 wherein said padding layer further includes a plurality of inelastic beads mixed with said elastic beads with portions of some of the elastic beads abutting portions of adjacent inelastic beads and being integrally joined thereto.

31. A multi-layered flooring composite, said composite including an upper layer of substantially hard material and a lower layer of substantially hard material and at least one acoustic layer positionable therebetween, said acoustic layer including a plurality of discrete beads wherein portions of adjacent beads abut one another and other portions of said adjacent beads are spaced from each other to create spaces therebetween.

32. The flooring composite of claim 31 wherein substantially all of said adjacent beads are integrally joined together at the abutting portions thereof.

33. The flooring composite of claim 31 wherein at least some of said beads are made of elastic, resilient material.

34. The flooring composite of claim 31 wherein at least some of said beads are made of inelastic material.

35. The flooring composite of claim 31 wherein said spaces between said other portions of said adjacent beads are in fluid communication with one another.

36. The flooring composite of claim 31 wherein at least some of said beads have substantially truncated spherical shapes.

37. The flooring composite of claim 31 wherein at least some of said beads have truncated spherical shapes with at least one substantially flat, horizontal surface wherein at least some of said flat surfaces are coplanar.

38. The flooring composite of claim 32 wherein said coplanar surfaces are positioned substantially adjacent said upper layer.

39. The flooring composite of claim 31 further including a substantially moisture-proof film layer positioned adjacent said acoustic layer.

40. The flooring composite of claim 31 further including non-woven fabric positioned atop said acoustic layer between the acoustic layer and the upper layer.

41. The flooring composite of claim 31 wherein said beads are made of closed cell foam.

42. The flooring composite of claim 31 wherein the beads of said acoustic layer are made of closed cell foam and are about 75%-95% air.

43. The flooring composite of claim 31 wherein the spaces between said other portions of said adjacent beads make up about 35% to 45% of the total volume of the acoustic layer.

44. The flooring composite of claim 31 wherein the beads of said acoustic layer are made of closed-cell foam and the total volume of the acoustic layer including the beads and the spaces between said other portions of said adjacent beads is about 75% to 95% air.
